(19) United States
(12) Patent Application Publication
(10) Pub. No.: US 2018/0103352 A1
(43) Pub. Date: Apr. 12, 2018

(54) POSITION CALCULATION DIVCE AND POSITION CALCULATION METHOD

(71) Applicant: FUJITSU LIMITED, Kawasaki-shi (JP)

(72) Inventors: Yuichi Murase, Yokohama (JP); Katsushi Sakai, Zama (JP)

(73) Assignee: FUJITSU LIMITED, Kawasaki-shi (JP)

(21) Appl. No.: 15/725,875

(22) Filed: Oct. 5, 2017

(30) Foreign Application Priority Data
Oct. 12, 2016 (JP) 2016-201270

(51) Int. Cl. H04W 4/04; H04W 4/02

(52) U.S. Cl. CPC H04W 4/043; G01S 1/14; H04W 4/027

(57) ABSTRACT

A position calculation device includes, a memory, and a processor coupled to the memory and the processor configured to, receive a first beacon signal transmitted from a first transmitter installed in a first floor and a second beacon signal transmitted from a second transmitter installed in a second floor, perform a first determination of a floor where the position calculation device is positioned based on measurement information of a motion sensor, perform a second determination of a specific beacon signal from among the first beacon signal and the second beacon signal, the specific beacon signal corresponding to the determined floor, and calculate a first position of the position calculation device based on the specific beacon signal.

### CROSS-REFERENCE TO RELATED APPLICATION

This application is based upon and claims the benefit of priority of the prior Japanese Patent Application No. 2016-201270, filed on Oct. 12, 2016, the entire contents of which are incorporated herein by reference.

### FIELD

The embodiments discussed herein are related to a position calculation device, and a position calculation method.

### BACKGROUND

With development of a portable information processing terminal such as a smartphone, a walking trace of an owner of a portable information processing terminal (hereinafter, referred to as a user) may be identified on a map. In outdoors, a position where a portable information processing terminal is positioned may be measured by receiving radio waves from a plurality of global positioning system (GPS) satellites. However, in a case of indoors or underground, radio waves may not be received from GPS satellites in some cases. For this reason, a technique for estimating a walking trace of a pedestrian on a map based on pedestrian dead reckoning using an angular velocity sensor and an acceleration sensor, is known.

In the pedestrian dead reckoning, a position error due to drift of a sensor or a stride of a user is accumulated by integration of sensor output. As a result, a technique of providing a communication apparatus which transmits a beacon signal and of which the position is known on an environment side and suppressing an increase in position error by using wireless information such as an intensity of a beacon signal received from the communication apparatus, is used.

Related technologies are disclosed in, for example, Japanese National Publication of International Patent Application No. 2014-504943, Japanese Laid-open Patent Publication No. 2005-114537, and Japanese Laid-open Patent Publication No. 2009-210473.

### SUMMARY

According to an aspect of the invention, a position calculation device includes, a memory, and a processor coupled to the memory and the processor configured to, receive a first beacon signal transmitted from a first transmitter installed in a first floor and a second beacon signal transmitted from a second transmitter installed in a second floor, perform a first determination of a floor where the position calculation device is positioned based on measurement information of a motion sensor, perform a second determination of a specific beacon signal from among the first beacon signal and the second beacon signal, the specific beacon signal corresponding to the determined floor, and calculate a first position of the position calculation device based on the specific beacon signal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of an information processing system according to a first embodiment;

FIG. 2 is a block diagram schematically illustrating an example of a functional configuration of a motion detection device according to the first embodiment;

FIG. 3 is a diagram for explaining a gait;

FIG. 4 is a diagram illustrating an example of a place where the motion detection device according to the first embodiment is fixed to a user;

FIG. 5 is a block diagram schematically illustrating an example of a functional configuration of an information processing apparatus according to the first embodiment;

FIG. 6A is a diagram illustrating an example of a change of a pitch angular velocity with respect to time and an example of a change of an integral profile of the pitch angular velocity with respect to time when a user is walking, the integral profile being obtained by integrating the pitch angular velocity with respect to time;

FIG. 6B is a diagram illustrating another example of a change of a pitch angular velocity with respect to time and another example of a change of an integral profile of the pitch angular velocity with respect to time when a user is walking, the integral profile being obtained by integrating the pitch angular velocity with respect to time;

FIG. 7 is a diagram illustrating an example of a definition of a start of a walking period;

FIG. 8 is a diagram illustrating an example of the integral profile of the pitch angular velocity due to a difference in a gait;

FIG. 9 is a flowchart illustrating an example of a procedure of processing in the information processing apparatus according to the first embodiment;

FIG. 10 is a flowchart illustrating an example of a procedure of movement information acquisition processing according to the first embodiment;

FIG. 11 is a flowchart illustrating an example of a procedure of gait determination processing according to the first embodiment;

FIG. 12 is a diagram illustrating an example of a position calculation method according to the first embodiment and a comparative example;

FIG. 13 is a block diagram schematically illustrating an example of a functional configuration of a motion detection device according to a second embodiment;

FIG. 14 is a block diagram schematically illustrating an example of a functional configuration of an information processing apparatus according to the second embodiment;

FIG. 15A is a diagram illustrating an example of an outline of posture stability determination according to the second embodiment;

FIG. 15B is a diagram illustrating another example of an outline of posture stability determination according to the second embodiment;

FIG. 16 is a flowchart illustrating an example of a procedure of movement information acquisition processing according to the second embodiment;

FIG. 17 is a flowchart illustrating an example of a procedure of gait determination processing according to the second embodiment;

FIG. 18 is a diagram illustrating an example of a configuration of an information processing system according to a third embodiment;

FIG. 19 is a block diagram schematically illustrating an example of a functional configuration of a position management server according to the third embodiment; and

FIG. 20 is a diagram illustrating a hardware configuration of a computer that executes a position calculation program according to the first embodiment to the third embodiment.

### DESCRIPTION OF EMBODIMENTS

In conventional technology, in an environment where there are a plurality of floors in a building under construction or an open space, there is a case where a beacon signal from a communication apparatus installed in each floor may be detected in another floor different from the floor of the installed place. For example, in a state where a user is present in a first floor, a beacon signal from a communication apparatus installed in a second floor leaks to the first floor, and as a result, in some cases, the beacon signal may be received by a portable information processing terminal of the user. In this case, the portable information processing terminal determines that the user is present in the second floor where the communication apparatus which transmits the beacon signal is installed, and estimates a position of the user. In other words, reliability of user position estimation is decreased.

Hereinafter, embodiments of an information processing apparatus, a position calculation method, and a position calculation program disclosed in the present disclosure will be described in detail with reference to the drawings. The present disclosure is not limited to the embodiments.

### First Embodiment

System Configuration

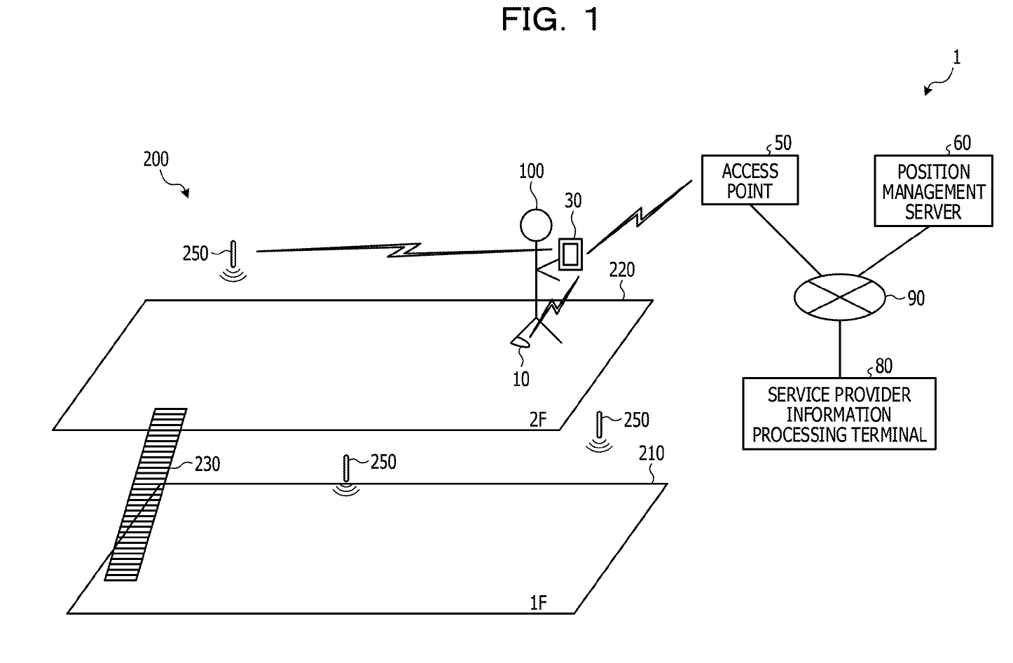

FIG. 1 is a diagram illustrating an example of a configuration of an information processing system according to a first embodiment. The information processing system 1 includes a motion detection device 10 fixed to a user 100, an information processing apparatus 30 possessed by the user 100, a position management server 60, a service provider information processing terminal 80, and a communication apparatus 250.

As an example, the information processing system 1 is used for position management of a user in a building 200 such as a building having a plurality of floors, or an underpass. In the information processing system 1, the position management server 60 manages position information of the user 100, and the service provider information processing terminal 80 provides a service to the user 100 by using the position information of the user 100. For example, a site manager or a worker in the building 200 under construction is the user 100, and a service provider provides information for the user 100 to the information processing apparatus 30 possessed by the user 100 according to a position of the user 100. Alternatively, an occupant of a nursing facility or a patient of a hospital is the user 100, and the service provider provides a so-called monitoring service that allows recognition of a state of the user 100 according to the position of the user 100.

The floors 210 and 220 of the building 200 are connected to each other by a stairway 230. The communication apparatus 250 is installed in each of the floors 210 and 220 of the building 200. The communication apparatus 250 is a transmitter that transmits a signal including information specifying an installation position in the building 200. As a signal transmitted from the communication apparatus 250, for example, an optical beacon signal or a radio wave beacon signal may be used. Hereinafter, the signal transmitted from the communication apparatus 250 will be referred to as a beacon signal. Although FIG. 1 illustrates a case where the building 200 has two floors 210 and 220, the number of floors installed in the building 200 may be any number of two or more.

The user 100 possesses the motion detection device 10 and the information processing apparatus 30. The motion detection device 10 is a device that detects movement information for calculating a walking trace of the user 100 by pedestrian dead reckoning and movement information for determining a walking motion of the user 100 at a flat place or a walking motion of ascending/descending at the stairway 230, and that transmits the detected motion information to the information processing apparatus 30.

The information processing apparatus 30 calculates the position of the user 100 using the movement information acquired from the motion detection device 10, and resets the position of the user 100 using the beacon signal from the communication apparatus 250. In addition, the information processing apparatus 30 transmits the calculated position or the reset position, to the position management server 60. Further, the information processing apparatus 30 specifies a gait of the user 100 by using the information acquired from the motion detection device 10, and selects use of the position resetting using the received beacon signal. Examples of the information processing apparatus 30 include a mobile phone, a smartphone, a tablet terminal, a personal digital assistant (PDA), and the like. In FIG. 1, although only one user 100 is illustrated, there may be any number of users 100 in the information processing system 1.

An access point 50, the position management server 60, and the service provider information processing terminal 80 are connected to each other via a network 90. As the network 90, any type of communication network such as the Internet, a local area network (LAN), a wide area network (WAN), or a virtual private network (VPN) may be adopted, regardless of wired communication or wireless communication.

The access point 50 is a relay apparatus that connects the information processing apparatus 30 possessed by the user 100 to the network 90. The information processing apparatus 30 and the access point 50 are connected to each other by, for example, wireless communication. The access point 50 includes a network interface card (NIC) as a communication unit.

The position management server 60 acquires the position information of the user 100, from the information processing apparatus 30 of the user 100 that uses the information processing system 1, and provides the position information of the user 100 according to a request from the service provider information processing terminal 80.

The service provider information processing terminal 80 acquires the position of the user 100 from the position management server 60, and transmits an instruction according to the position of the user 100, to the information processing apparatus 30 of the user 100. For example, in a case where the user 100 who is a worker of the building 200 exists at a predetermined position in the building 200, the service provider information processing terminal 80 transmits information desired to be executed by the user 100, to the information processing apparatus 30 of the user 100. In addition, in a case where the user 100 who is an occupant of a nursing facility exists in a restricted area of the building 200, the service provider information processing terminal 80 outputs warning information to the information processing apparatus 30 of the user 100 such that the user 100 leaves from the current area. The cases are only examples, and the service provider information processing terminal 80 may output information according to the position of the user 100 in the building 200.

Next, detailed configurations of the motion detection device 10 and the information processing apparatus 30 included in the information processing system 1 will be described.

Functional Configuration of Motion Detection Device 10

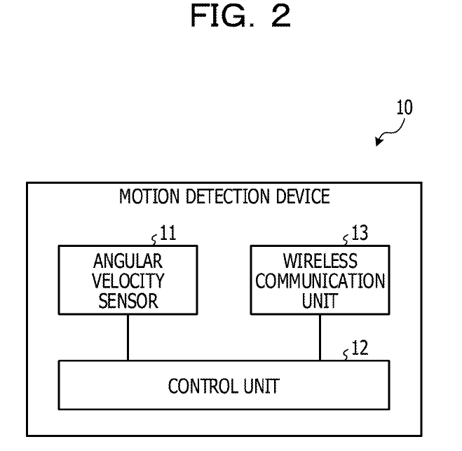

FIG. 2 is a block diagram schematically illustrating an example of a functional configuration of a motion detection device according to the first embodiment. The motion detection device 10 is, for example, a wearable device that detects the walking motion of the user 100, and as illustrated in FIG. 2, the motion detection device 10 includes an angular velocity sensor 11, a control unit 12, and a wireless communication unit 13.

The angular velocity sensor 11 is a kind of a motion sensor that detects the motion of the user 100, is mounted to a lower half body below a waist of the user 100, and detects an angular velocity of the user 100. A displacement angle indicating a change in a direction when the user 100 moves, a walking period of the user 100, and a gait of the user may be obtained based on the angular velocity. In this specification, a gait indicates a state of walking such as walking on a flat place, walking when ascending a stairway, and walking when descending a stairway.

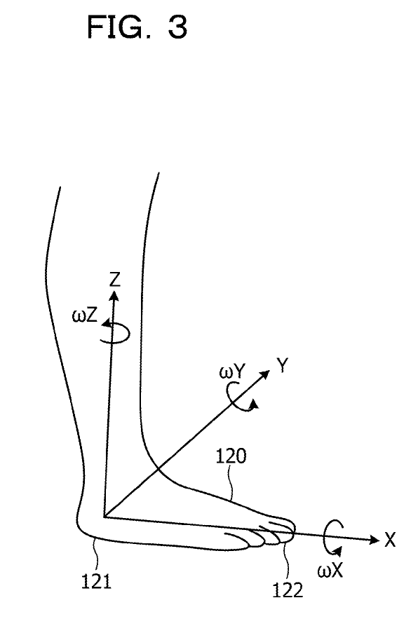

FIG. 3 is a diagram for explaining a gait. In FIG. 3, a direction from a heel 121 of a foot 120 of the user 100 toward a toe 122 of the foot, that is, an axis in a traveling direction of the user 100, is set to an X axis, a direction from the heel 121 toward a height direction is set to a Z axis, and an axis perpendicular to both of the X axis and the Z axis is set to a Y axis. Rotations around the X axis, the Y axis, and the Z axis are set to roll, pitch, and yaw, respectively. At this time, angular velocities of roll, pitch, and yaw are set to a roll angular velocity ωX, a pitch angular velocity ωY, and yaw angular velocity ωZ, respectively.

When defining the axes in this way, a waveform indicating a change in the pitch angular velocity ωY with respect to time in one walking motion of the user 100, more specifically, a waveform obtained by integrating time-series data (or waveform) of the pitch angular velocity ωY with respect to time during one walking motion of the user 100, varies depending on a gait. In this embodiment, the pitch angular velocity ωY is used for gait determination. Here, this is merely an example. In a case where the gait determination may be performed using the roll angular velocity ωX or the yaw angular velocity ωZ, the roll angular velocity ωX or the yaw angular velocity ωZ may be used.

In a case of obtaining a gait, it is good that the pitch angular velocity ωY is known. On the other hand, in a case of obtaining the displacement angle as an angular change of the user 100 that is used for calculating a position (walking trace) of the user by pedestrian dead reckoning, in order to use the three-axis angular velocities of the roll angular velocity ωX, the pitch angular velocity ωY, and the yaw angular velocity ωZ, a three-axis angular velocity sensor may be used.

The control unit 12 has a function of generating a signal including the angular velocity detected by the angular velocity sensor 11 and transmitting a signal from the wireless communication unit 13.

In one embodiment, the control unit 12 is mounted as a central processor, a so-called central processing unit (CPU). The CPU develops a program for realizing generation of the radio signal on a work area of a random access memory (RAM) mounted as a main memory device (not illustrated), as a process. As the RAM, a dynamic RAM (DRAM), a static RAM (SRAM), or the like may be used. In addition, the program is stored in, for example, a read only memory (ROM) or the like.

The control unit 12 may not be mounted as a central processor, and may be mounted as a micro processing unit (MPU) or a micro controller unit (MCU). In addition, the control unit 12 may also be realized by a hard-wired logic such as an application specific integrated circuit (ASIC) or a field programmable gate array (FPGA).

The wireless communication unit 13 performs wireless communication with the information processing apparatus 30. The wireless communication unit 13 is realized by, for example, a Bluetooth (registered trademark) low energy (BLE) chip, a wireless LAN chip, or the like.

Fixed Position of Motion Detection Device 10

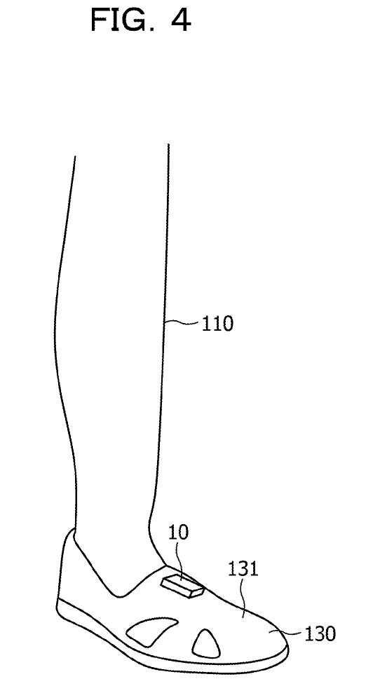

The motion detection device 10 is fixed to a body below a waist of the user 100. In one embodiment, the motion detection device 10 is fixed to a top of the foot of the user 100. FIG. 4 is a diagram illustrating an example of a place where the motion detection device according to the first embodiment is fixed to the user. In one embodiment, as illustrated in FIG. 4, the motion detection device 10 is fixed to footwear 130 such as shoes, sandals, or slippers. In FIG. 4, although a case where the motion detection device 10 is fixed to an upper portion 131 of the footwear 130 is illustrated, the motion detection device 10 is fixed to any place of the footwear 130. For example, the motion detection device 10 may be fixed so as to be embedded in a bottom portion of the footwear 130, or the motion detection device 10 may be fixed so as to be embedded in an insole of the footwear 130.

In addition, in other embodiments, the motion detection device 10 may be fixed to the user 100 by winding a fixture including the motion detection device 10 around a thigh of the user 100. The fixture is, for example, a supporter or the like. In addition, the motion detection device 10 is fixed to any place of a leg 110. For example, the motion detection device 10 may be fixed by winding the fixture around a knee, a calf, or an ankle. The motion detection device 10 may be fixed to one leg or may be fixed to both legs. In the following embodiments, a case where the motion detection device 10 is fixed to one leg will be described.

Further, in other embodiments, the motion detection device 10 may be fixed to a waist of the user 100. For example, the motion detection device 10 is fixed to a holder wound around the waist of the user 100.

Functional Configuration of Information Processing Apparatus 30

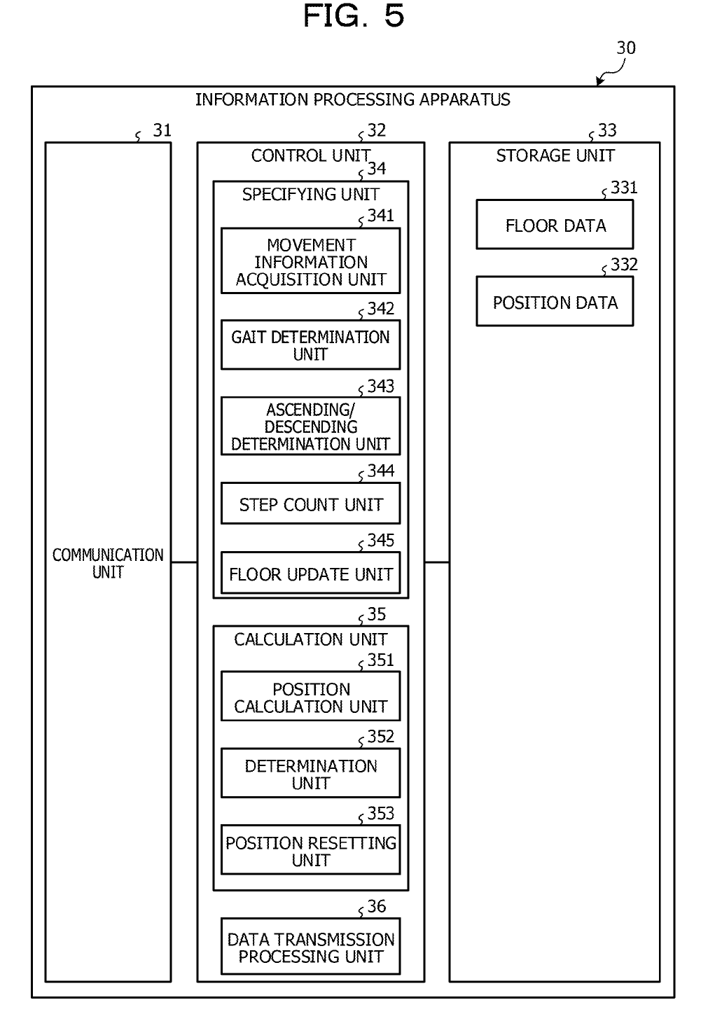

FIG. 5 is a block diagram schematically illustrating an example of a functional configuration of the information processing apparatus according to the first embodiment. The information processing apparatus 30 includes a communication unit 31, a control unit 32, and a storage unit 33.

The communication unit 31 has a function of receiving a beacon signal from the communication apparatus 250 and a function of transmitting the current position of the user 100 that is calculated by the control unit 32 to the position management server 60 via the access point 50. In the communication unit 31, the function of receiving the beacon signal corresponds to a reception unit, and the reception unit is realized by, for example, a BLE chip. In the communication unit 31, the function of transmitting the current position to the position management server 60 is realized by, for example, NIC.

The control unit 32 includes a specifying unit 34, a calculation unit 35, and a data transmission processing unit 36. The control unit 32 is mounted as a central processor, a so-called CPU. The CPU develops an application program for realizing position calculation to be described later, on a work area of a RAM mounted as a main memory device (not illustrated), as a process. As the RAM, DRAM, SRAM, or the like may be used. In addition, the application program is stored in, for example, a ROM, or an HDD.

The control unit 32 may not be mounted as a central processor, and may be mounted as a MPU or a MCU. In addition, the control unit 32 may also be realized by a hard-wired logic such as an ASIC or an FPGA.

The specifying unit 34 acquires gait data of the user 100 from the movement information detected by the motion detection device 10, and specifies a floor where the user 100 is positioned based on the gait data of the user 100. The specifying unit 34 includes a movement information acquisition unit 341, a gait determination unit 342, an ascending/descending determination unit 343, a step count unit 344, and a floor update unit 345.

The movement information acquisition unit 341 acquires the movement information as a detection result of the angular velocity sensor 11 that is received via the communication unit 31. In the first embodiment, for calculation of a walking trace of the user 100 using pedestrian dead reckoning and determination of a gait, the movement information acquisition unit 341 acquires time series data of the roll angular velocity ωX, the pitch angular velocity ωY, and the yaw angular velocity ωZ. Specifically, the movement information acquisition unit 341 determines one period of a walking motion of a certain user 100 (hereinafter, referred to as “a walking period”), and buffers the three-axis angular velocities detected by the motion detection device 10 during a walking period. For example, the movement information acquisition unit 341 sets a start of a stationary section in which the pitch angular velocity ωY is substantially 0, to a boundary point of a walking period. An interval from a boundary point detected in the previous walking period to a boundary point detected in the current walking period, is set as a walking period. In a case where the motion detection device 10 is fixed to one leg, a walking period of the user 100 is two steps. In addition, in a case where the motion detection device 10 is fixed to two legs, a walking period of the user 100 is one step.

The gait determination unit 342 performs gait determination processing using data of the pitch angular velocity ωY during a walking period. In the gait determination processing, the gait determination unit 342 acquires an integral profile by integrating the time series data (or waveform) of the pitch angular velocity ωY with respect to time, extracts a peak pattern of the integral profile in each walking period, and determines a gait based on the peak pattern. By using the pitch angular velocity ωY in FIG. 3, it is possible to detect a difference in a gait of the user 100.

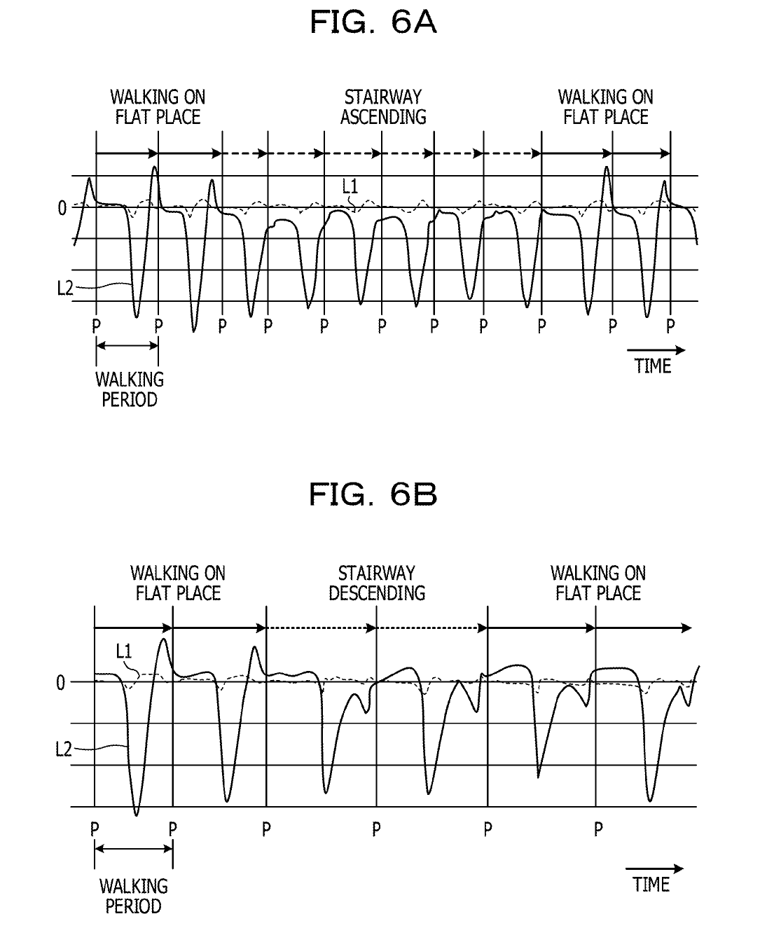

FIGS. 6A and 6B are diagrams illustrating an example of a change of the pitch angular velocity ωY with respect to time and an example of a change of the integral profile of the pitch angular velocity ωY with respect to time when the user is walking, the integral profile being obtained by integrating the pitch angular velocity ωY with respect to time. FIG. 6A is a diagram illustrating a change of the pitch angular velocity ωY and a change of the integral profile of the pitch angular velocity ωY when the user ascends a stairway from a flat place. FIG. 6B is a diagram illustrating a change of the pitch angular velocity ωY and a change of the integral profile of the pitch angular velocity ωY when the user descends a stairway from a flat place. In FIGS. 6A and 6B, a horizontal axis represents time. In addition, the change of the pitch angular velocity ωY with respect to time is indicated by a broken line graph L1, and the change of the integral profile of the pitch angular velocity ωY with respect to time is indicated by a solid line graph L2.

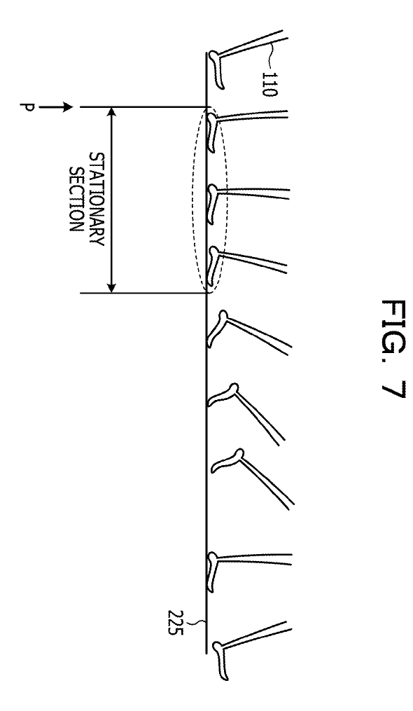

FIG. 7 is a diagram illustrating an example of a definition of a start of a walking period. FIG. 7 schematically illustrates a temporal change in walking of the user 100. Generally, in walking of a human, a foot of one leg 110 lands on a ground 225 from a heel, and the entire sole of the foot contacts on the ground 225 for a predetermined time. Then, the heel floats from the ground, the foot kicks the ground 225 with toes, and a heel of the other leg 110 lands on the ground 225. Thereafter, the above-described operation is alternately performed for each leg 110, and walking is performed.

When the entire sole of the foot contacts on the ground 225, there is a section where rotation around the Y axis of an ankle stops, that is, a stationary section where the pitch angular velocity is substantially 0 (ωY˜0). When a state where the pitch angular velocity ωY is substantially 0, among the pitch angular velocity ωY in FIGS. 6A and 6B, continues for a predetermined period, the gait determination unit 342 determines that the predetermined period is a stationary section, and sets a beginning of the stationary section to a boundary point P (start) of a walking period. Here, the determination of the state where the pitch angular velocity ωY is substantially 0 is performed by determining whether or not the pitch angular velocity ωY is equal to or greater than 0−α and equal to or less than 0+β. In FIGS. 6A and 6B, the boundary point P of a walking period is determined in this manner. As described above, in the first embodiment, the motion detection device 10 is attached to only one leg. Thus, one walking period in FIGS. 6A and 6B corresponds to actual two steps.

The boundary point P of a walking period may be obtained by using a temporal change of the pitch angular velocity ωY. However, in the graph L1 of a temporal change of the pitch angular velocity ωY, a difference in pattern due to a difference in a gait within a walking period is not clear. On the other hand, as illustrated in the graph L2 of FIGS. 6A and 6B, in the integral profile of the pitch angular velocity ωY within one walking period, peak patterns are different from each other in walking on a flat place and walking when ascending/descending a stairway.

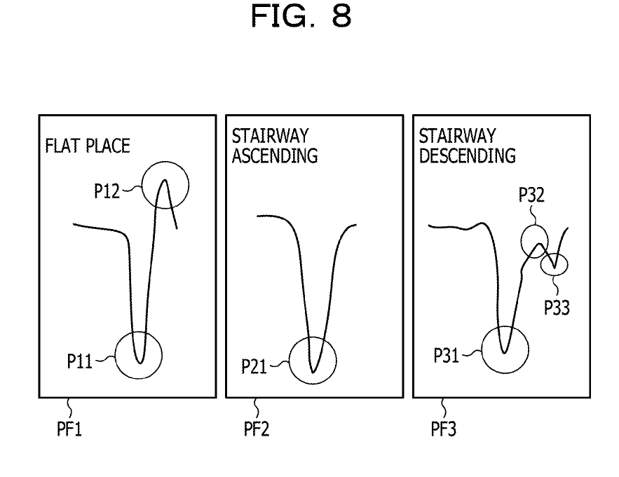

FIG. 8 is a diagram illustrating an example of the integral profile of the pitch angular velocity ωY due to a difference in a gait. An integral profile PF1 indicates a walking state on a flat place. In this peak pattern, a negative peak P11 and a positive peak P12 appear in order. An integral profile PF2 indicates a walking state when ascending a stairway. In this peak pattern, only a negative peak P21 appears. An integral profile PF3 indicates a walking state when descending a stairway. In this peak pattern, a negative peak P31, a positive peak P32, and a negative peak P33 appear in order.

As illustrated in FIG. 8, characteristic peak patterns may be obtained in walking on a flat place, walking when ascending a stairway, and walking when descending a stairway. Thus, for each walking period, by determining that the peak pattern of the integral profile corresponds to which one of the integral profiles PF1, PF2, and PF3 illustrated in FIG. 8, it is possible to determine a gait.

In FIG. 8, the integral profiles PF1 to PF3 indicating gaits illustrate an example when the motion detection device 10 is fixed to the top of the foot. In some cases, the integral profiles may also be changed depending on a fixed position of the motion detection device 10. In such a case, integral profiles that may distinguish a walking state on a flat place, a walking state when ascending a stairway, and a walking state when descending a stairway, may be used. In addition, instead of the pitch angular velocity ωY, an integral profile of the roll angular velocity ωX or the yaw angular velocity ωZ may be used for determining a gait.

The ascending/descending determination unit 343 determines whether or not a gait state is changed, based on the gait in each walking period that is acquired by the gait determination unit 342. For example, as a result of the gait determination, when the peak pattern of the integral profile changes from the walking state on a flat place, to the walking state when ascending a stairway or the walking state when descending a stairway, the ascending/descending determination unit 343 determines that stairway ascending/descending is started. In addition, as a result of the gait determination, when the peak pattern of the integral profile changes from the walking state when ascending a stairway or the walking state when descending a stairway, to the walking state on a flat place, the ascending/descending determination unit 343 determines that stairway ascending/descending is ended.

The step count unit 344 counts up the number of steps when the boundary point P of the walking period is detected by the movement information acquisition unit 341.

The floor update unit 345 updates the floor where the user is positioned when an end of stairway ascending/descending is detected by the ascending/descending determination unit 343. For example, when a transition from the walking state when ascending a stairway to the walking state on a flat place is detected, a new current floor is set by adding one to the current floor, and floor data which is used up to that point is updated to new floor data. In addition, when a transition from the walking state when descending a stairway to the walking state on a flat place is detected, a new current floor is set by subtracting one from the current floor, and floor data which is used up to that point is updated to new floor data.

The calculation unit 35 calculates a position of the user 100 based on the movement information from the motion detection device 10, and resets the position of the user 100 when a predetermined condition is satisfied. The calculation unit 35 further includes a position calculation unit 351, a determination unit 352, and a position resetting unit 353.

The position calculation unit 351 calculates a position coordinate of the information processing apparatus 30 (the user 100 possessing the motion detection device 10 and the information processing apparatus 30) that includes the floor data, by using the angular velocity acquired by the movement information acquisition unit 341 and the count result of the number of steps in the step count unit 344, based on pedestrian dead reckoning. More specifically, the position calculation unit 351 sets a distance (stride) corresponding to one walking period that is counted by the step count unit 344, to an estimated moving distance, and sets a rotation angle of the information processing apparatus 30 that is obtained by integrating the angular velocity included in the signal output from the angular velocity sensor 11 with respect to time, to an estimated displacement angle. By adding the estimated moving distance in a direction of the estimated displacement angle to a previously estimated position coordinate or a position coordinate to be reset that includes the floor data, the position calculation unit 351 estimates the current position coordinate of the information processing apparatus 30. The position calculation unit 351 stores the estimated position coordinate in the storage unit 33 together with time information, as position data 332. By linking the position at each time using a line, the walking trace of the user 100 may be obtained.

When receiving the beacon signal from the communication unit 31, the determination unit 352 determines whether the floor information included in the beacon signal is the same as information of the floor where the user 100 is positioned, which is managed by the floor update unit 345. In a case where both are the same, the determination unit 352 allows the position resetting unit 353 to perform position resetting processing using the received beacon signal. On other hand, in a case where both are not the same, the determination unit 352 does not allow the position resetting unit 353 to perform position resetting processing using the received beacon signal.

The position resetting unit 353 resets the walking trace or the position of the user 100 that is calculated by the position calculation unit 351, under a predetermined condition. When the position resetting is executed, an accumulated error included in the walking trace estimated by the position calculation unit 351, is removed. The position resetting unit 353 stores the reset position coordinate in the storage unit 33 together with time information, as position data 332.

In one embodiment, in a case where the determination unit 352 allows the position resetting processing using the beacon signal, the position resetting unit 353 measures an intensity of the beacon signal. In a case where the intensity of the beacon signal is greater than a predetermined intensity, the position resetting unit 353 resets the position of the user 100, to a position of the communication apparatus 250 which transmits the beacon signal that includes the floor data. In a case where the intensity of the beacon signal is less than the predetermined intensity, resetting of the position of the user 100 is not performed. In addition, in a case where the intensity of the beacon signal is equal to the predetermined intensity, resetting of the position of the user 100 may be performed or not performed.

In addition, in one embodiment, in a case where the ascending/descending determination unit 343 detects switching between walking on a flat place and walking when ascending/descending a stairway, the position resetting unit 353 resets the position of the user 100, to an upward entrance or a downward entrance of a stairway closest to the estimated position of the user 100 at that time that includes the floor data.

The data transmission processing unit 36 transmits the position calculated by the position calculation unit 351 or the position which is reset by the position resetting unit 353, to the position management server 60, together with time information and information specifying the user 100.

The storage unit 33 stores the floor data 331 and the position data 332. The floor data 331 is map information, which indicates a disposition state such as positions of a passage, a room, the communication apparatus 250, an upward entrance of the stairway 230, a downward entrance of the stairway 230 in each floor of the building 200, with respect to a certain position as a coordinate reference. The floor data 331 is prepared for each floor of the building 200.

The position data 332 stores the position calculated by the position calculation unit 351 or the position which is reset by the position resetting unit 353, together with the time information, for each user 100.

The storage unit 33 is mounted as, for example, a hard disk drive (HDD) or a solid state drive (SSD).

Processing Flow

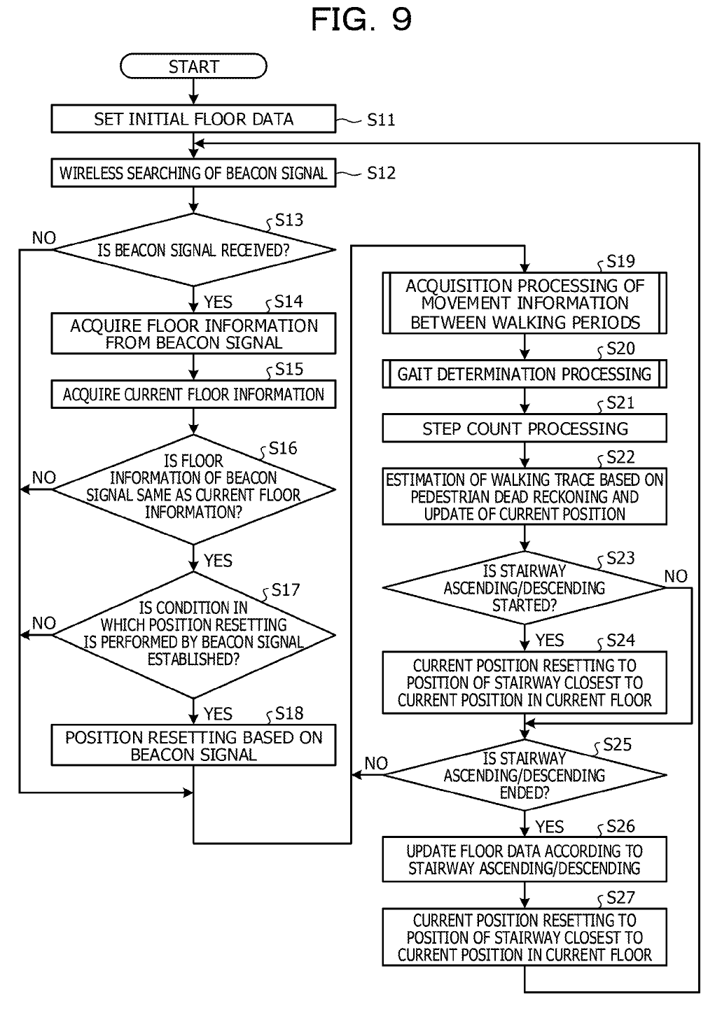

FIG. 9 is a flowchart illustrating an example of a procedure of processing in the information processing apparatus according to the first embodiment. This processing is performed by the information processing apparatus 30 possessed by the user 100 who fixes the motion detection device 10 to the lower half body below the waist.

First, the floor update unit 345 acquires data of an initial floor where the information processing apparatus 30 is positioned, from the floor data 331 stored in the storage unit 33, and sets the acquired data to initial floor data (step S11). Then, the communication unit 31 performs wireless searching of a beacon signal (step S12). The wireless searching of a beacon signal is performed so as to determine whether there is a beacon signal to be registered in the floor data which is set. The beacon signal includes apparatus identification information of the communication apparatus 250 which transmits the beacon signal and position information indicating a position where the communication apparatus 250 is installed. In addition, the position information includes information indicating a floor and a position in each floor.

Thereafter, the communication unit 31 determines whether a beacon signal is received (step S13). In a case where a beacon signal is received (Yes in step S13), floor information included in the beacon signal is acquired (step S14). Subsequently, the determination unit 352 acquires current floor information which is set on the information processing apparatus 30 side (step S15). The current floor information is acquired by, for example, acquiring floor information of current floor data which is managed by the floor update unit 345. Thereafter, the determination unit 352 determines whether the floor information of the beacon signal is the same as the current floor information (step S16).

In a case where the floor information of the beacon signal is the same as the current floor information (Yes in step S16), the determination unit 352 determines whether a condition in which the position resetting may be performed by the beacon signal is established (step S17). For example, the determination unit 352 determines whether the intensity of the beacon signal received by the communication unit 31 is greater than an intensity when executing the position resetting.

In a case where the condition in which the position resetting may be performed by the beacon signal is satisfied (Yes in step S17), the position resetting unit 353 resets the position of the user 100 based on the received beacon signal (step S18). More specifically, in a case where the intensity of the beacon signal is greater than an intensity at which the position resetting may be performed, the position resetting unit 353 resets the position of the communication apparatus 250 that transmits the beacon signal, to the position of the user 100.

Thereafter, in a case where the beacon signal is not received in step S13 (No in step S13), in a case where the floor information of the beacon signal is not the same as the current floor information in step S16 (No in step S16), or in a case where the condition in which the position resetting may be performed by the beacon signal is not established in step S17 (No in step S17), acquisition processing of the movement information between the walking periods is performed (step S19).

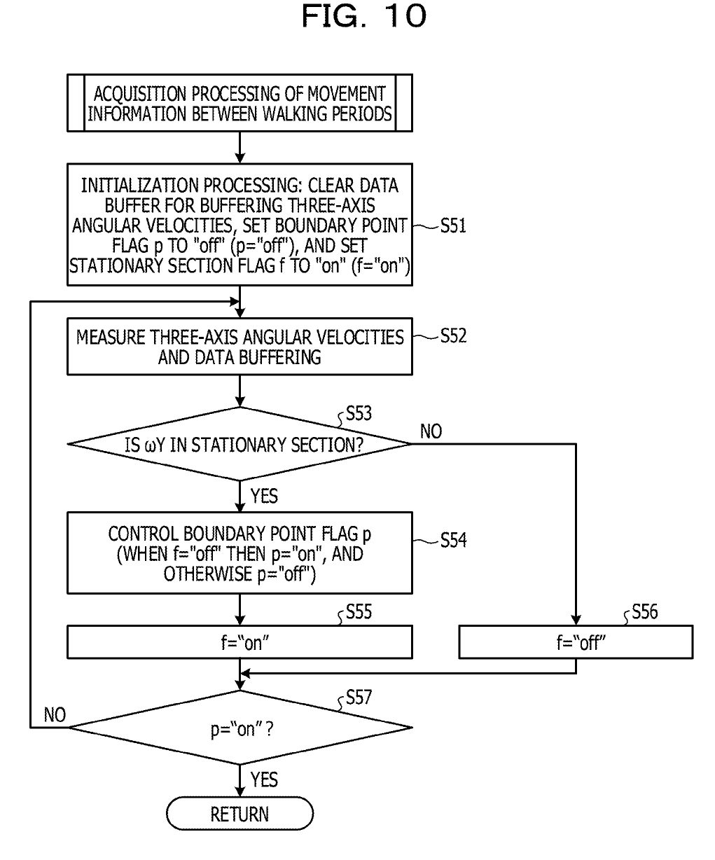

FIG. 10 is a flowchart illustrating an example of a procedure of movement information acquisition processing according to the first embodiment. In the movement information acquisition processing, first, the movement information acquisition unit 341 performs initialization processing (step S51). In the initialization processing, for example, a data buffer for buffering the angular velocities from the three-axis angular velocity sensor is cleared. In addition, a boundary point flag p is set to “off”, and a stationary section flag f is set to “on”. The boundary point flag p is a flag indicating completion of buffering of movement information (or start of buffering of next movement information). In addition, the stationary section flag f is a flag indicating a stationary section.

Subsequently, the movement information acquisition unit 341 acquires movement information from the angular velocity sensor 11 of the motion detection device 10 via the communication unit 31, and buffers the movement information in the data buffer (step S52). Thereafter, the movement information acquisition unit 341 determines whether the pitch angular velocity ωY is in a stationary section, that is, whether the pitch angular velocity ωY is substantially zero (step S53).

In a case where the pitch angular velocity ωY is in a stationary section (Yes in step S53), the movement information acquisition unit 341 controls the boundary point flag p (step S54). Specifically, in a case where the stationary section flag f is “off”, the boundary point flag p is set to “on”, and otherwise, the boundary point flag p is set to “off”. In time-series data of the pitch angular velocity ωY, a time point at which the boundary point flag p is set to “on” is the boundary point P. Thereafter, the movement information acquisition unit 341 sets the stationary section flag f to “on” (step S55).

On the other hand, in a case where the pitch angular velocity ωY is not in a stationary section (No in step S53), the movement information acquisition unit 341 sets the stationary section flag f to “off” (step S56).

Thereafter, or after step S55, the movement information acquisition unit 341 determines whether the boundary point flag p is “on” (step S57). In a case where the boundary point flag p is not “on” (No in step S57), the process returns to step S52. That is, in a case where the boundary point flag p is “off”, buffering of movement information is performed.

On the other hand, in a case where the boundary point flag p is “on” (Yes in step S57), the process returns to processing of FIG. 9. That is, when a transition from a state where the stationary section flag f is “off” to a state where the pitch angular velocity ωY is in a stationary section is performed, the boundary point flag p is set to “on”, and the buffering of the movement information ends.

Returning to the processing illustrated in FIG. 9, after the acquisition processing of the movement information between the walking periods is performed, the gait determination unit 342 performs gait determination processing (step S20).

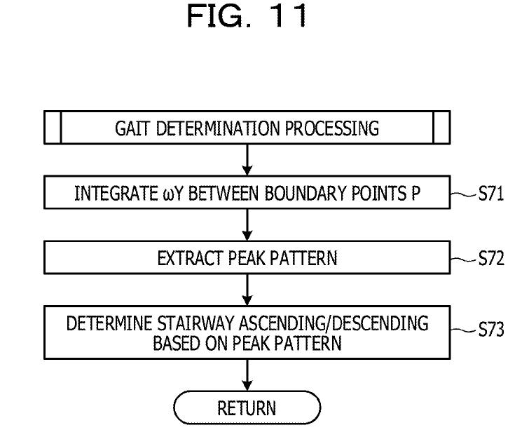

FIG. 11 is a flowchart illustrating an example of a procedure of gait determination processing according to the first embodiment. First, the gait determination unit 342 sets a distance between a currently detected boundary point P and a previously detected boundary point P, to a walking period, and integrates time-series data (or waveform) of the pitch angular velocity ωY among the buffered movement information, with respect to time (step S71). Thus, an integral profile in the walking period is acquired. Next, the gait determination unit 342 extracts a peak pattern in the walking period (step S72).

Thereafter, the ascending/descending determination unit 343 determines whether or not the user 100 ascends or descends the stairway 230 based on the extracted peak pattern (step S73). This determination is performed, for example, by determining that the acquired peak pattern corresponds to which one of the peak pattern of the integral profile PF1 when walking on a flat place, the peak pattern of the integral profile PF2 when ascending a stairway, and the peak pattern of the integral profile PF3 when descending a stairway that are illustrated in FIG. 8. By the above-described procedure, the process returns to the processing of FIG. 9.

Returning again to the processing illustrated in FIG. 9, in step S19, that is, in the acquisition processing of the movement information between the walking periods, when it is detected that the boundary point flag p is set to “on”, the step count unit 344 counts up the number of steps (step S21).

Subsequently, the position calculation unit 351 performs estimation of the walking trace based on pedestrian dead reckoning and update of the current position, by using the movement information detected by the angular velocity sensor 11 and the step count result in step S21 (step S22). A predetermined value is used as a distance corresponding to one step count. In the case of the first embodiment, since the motion detection device 10 is fixed to one leg, a distance corresponding to two steps of the user 100 is used. In addition, in a case where the motion detection device 10 is fixed to both legs, a distance (stride) corresponding to one step of the user 100 is used.

Thereafter, the ascending/descending determination unit 343 determines whether or not the user 100 starts stairway ascending/descending based on the gait determination result obtained by the gait determination unit 342 (step S23). For example, in a case where the gait determination result in the previous walking period is walking on a flat place and the latest gait determination result is walking when ascending/descending a stairway, the ascending/descending determination unit 343 may determine that stairway ascending/descending is started.

In a case where it is determined that the user 100 starts stairway ascending/descending (Yes in step S23), the position resetting unit 353 resets the current position of the user 100, to a position of the stairway in the current floor that is closest to the position estimated in step S22 (step S24).

In a case where it is determined that the user 100 does not start stairway ascending/descending in step S23 (No in step S23), the ascending/descending determination unit 343 determines whether the stairway ascending/descending is ended (step S25). For example, in a case where the gait determination result in the previous walking period is walking when ascending/descending a stairway and the latest gait determination result is walking on a flat place, the ascending/descending determination unit 343 may determine that stairway ascending/descending is ended.

In a case where it is determined that stairway ascending/descending is not ended (No in step S25), the process returns to step S19. This is based on a premise that the communication apparatus 250 which transmits the beacon signal is not installed at a stairway, and thus processing of steps S12 to S18 is omitted. On the other hand, in a case where the communication apparatus 250 is installed at a stairway, the process returns to step S12.

In a case where it is determined that stairway ascending/descending is ended (Yes in step S25), the floor update unit 345 updates the floor data when the user 100 completes stairway ascending/descending (step S26). For example, in a case where the user 100 ascends a stairway, the floor data 331, which is data of a floor positioned immediately above the current floor (a floor which is set by adding one to the current floor), is acquired from the storage unit 33. In addition, in a case where the user 100 descends a stairway, the floor data 331, which is data of a floor positioned immediately below the current floor (a floor which is set by subtracting one from the current floor), is acquired from the storage unit 33. Thus, the data of the floor where the user 100 is positioned is managed and updated by the floor update unit 345.

Thereafter, the position resetting unit 353 resets the current position of the user 100, to a position of the stairway in the current floor that is closest to the position estimated in step S22 (step S27), and the process returns to step S12. As described above, a flow of position calculation processing according to the first embodiment is described.

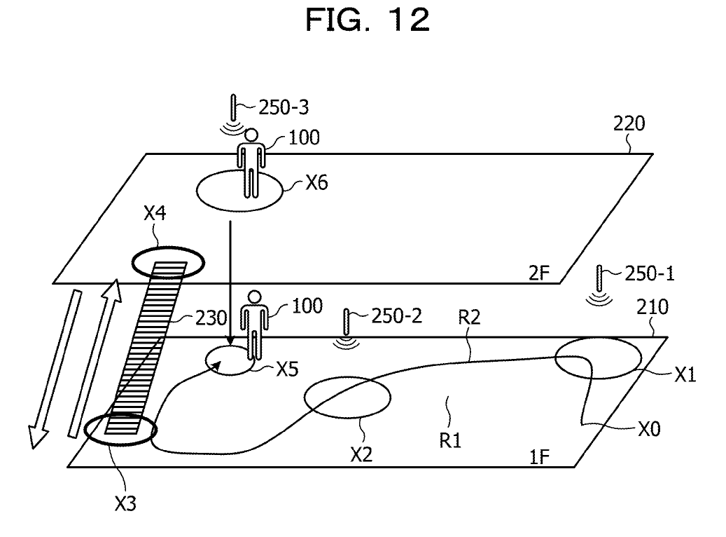

FIG. 12 is a diagram illustrating an example of a position calculation method according to the first embodiment and a comparative example. The user 100 moves in the first floor (1F) 210 of the building 200 from a position X0 as a starting point, the position of the user 100 is updated by pedestrian dead reckoning, and a route of a walking trace R1 is calculated. During the calculation, when receiving a beacon signal having an intensity greater than a predetermined intensity, the position of the user 100 is reset to the position of the communication apparatus 250 which transmits the beacon signal. For example, at a position X1, the position of the user 100 is reset to the position (information) of the communication apparatus 250-1 in the first floor (1F) 210. At a position X2, the position of the user 100 is reset to the position (information) of the communication apparatus 250-2 in the first floor (1F) 210.

Thereafter, it is assumed that the user 100 moves in the first floor (1F) 210 as illustrated in a walking trace R2. When the user 100 passes through the vicinity of the stairway 230 between the position X2 and a position X5, the information processing apparatus 30 of the user 100 receives a beacon signal which is leaked from the communication apparatus 250-3 in the second floor (2F) 220 to the first floor (1F) 210. At this time, in the comparative example, it is not determined whether the user 100 ascends or descends the stairway 230, and in a case where the intensity of the beacon signal is greater than the predetermined intensity, the position of the user 100 is reset to the position of the communication apparatus 250-3 that transmits the beacon signal. As a result, in the information processing apparatus 30, the walking trace R1 is calculated as a walking trace of the user 100.

As described above, in the comparative example, since it is not determined whether the user 100 ascends or descends the stairway 230, in contrast with the first embodiment, when receiving a beacon signal, the position resetting processing using the beacon signal may be performed. As a result, although the user 100 is actually present in the first floor (1F) 210, it is determined that the user 100 is present in the second floor (2F) 220, and this causes an error in the walking trace.

On the other hand, in the first embodiment, it is determined whether the user 100 ascends or descends the stairway 230. Thus, even in a case where a beacon signal having an intensity greater than the predetermined intensity is received at the position X5, when there is no motion of ascending the stairway 230 by the user 100, the position resetting processing using the beacon signal from the communication apparatus 250-3 is not performed. As a result, the information processing apparatus 30 calculates the walking trace R2 without movement between the floors 210 and 220 as the walking trace of the user 100. In other words, an error between an actual moving route of the user 100 and the walking trace of the user 100 may be decreased compared to the comparative example.

In addition, as another example, a case where the user 100 moves to a position X6 from the position X0 as a starting point, is considered. In this case, at the positions X1, X2, and X6, as a beacon signal is received from each of the communication apparatuses 250-1, 250-2, and 250-3, the current position of the user 100 is reset to the installation position of each communication apparatus.

In addition, in the information processing apparatus 30 according to the first embodiment, as indicated by the walking trace R1, at a position X3, a start of a motion of ascending the stairway 230 is detected, and at a position X4, an end of the motion of ascending the stairway 230 is detected. Then, at the position where the start of the motion of ascending the stairway 230 is detected, the position of the user 100 is reset to a position of an actual upward entrance of the stairway 230, and at the position where the end of the motion of ascending the stairway 230 is detected, the position of the user 100 is reset to a position of an actual downward entrance of the stairway 230. In this manner, even at the position of the upward entrance or the downward entrance of the stairway 230 other than the installation positions of the communication apparatuses 250-1 to 250-3, the position of the user 100 is reset, and thus it is possible to estimate the walking trace close to the actual moving route of the user 100.

Aspect of Effect

As described above, the information processing apparatus 30 according to the present embodiment records the floor movement in the building 200 as the user 100 ascends and descends the stairway, and when receiving a beacon signal, determines whether the floor information in the beacon signal matches with the floor information held in the information processing apparatus 30. As a result, when a walking trace is estimated by pedestrian dead reckoning, in a case where a beacon signal leaked from another floor is received, position correction using the beacon signal is not performed. Therefore, it is possible to reduce erroneous detection of the walking trace of the user 100.

In addition, by associating a change in a gait with the upward entrance or the downward entrance of the stairway 230 in the floor data, it is possible to reset the position of the user 100 when a change in a gait occurs. As a result, compared to a case where the position resetting is performed by using only the communication apparatus 250 that transmits a beacon signal, the number of points for resetting increases, and thus it is possible to more accurately estimate the walking trace of the user 100.

### Second Embodiment

Hereinafter, in the present embodiment, a case where an acceleration sensor is used for detecting a motion of the user in addition to the angular velocity sensor will be described. The overall configuration of the information processing system according to a second embodiment is the same as that illustrated in FIG. 1. In the following description, portions different from those of the first embodiment will be described.

Functional Configuration of Motion Detection Device 10

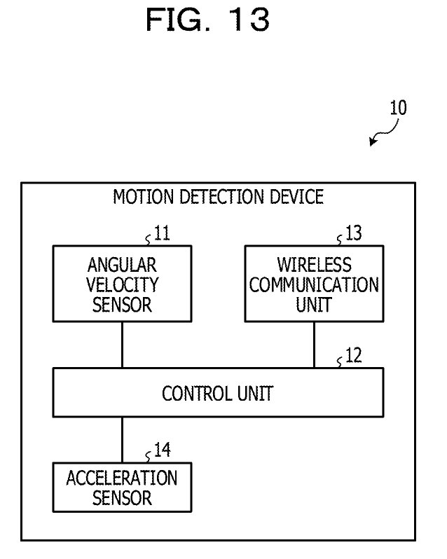

FIG. 13 is a block diagram schematically illustrating an example of a functional configuration of a motion detection device according to the second embodiment. As illustrated in FIG. 13, the motion detection device 10 further includes an acceleration sensor 14. The acceleration sensor 14 is a kind of a motion sensor that detects the motion of the user 100, is mounted to a lower half body below a waist of the user 100, and detects acceleration of the user 100. A change in the position of the user 100 at the time of movement may be obtained by the acceleration.

In FIG. 13, the same reference numerals are given to functional units that exhibit the same functions as the functional units illustrated in FIG. 2, and a description thereof is omitted. Here, the control unit 12 has a function of generating a signal including the angular velocity detected by the angular velocity sensor 11 and the acceleration detected by the acceleration sensor 14 and transmitting a signal from the wireless communication unit 13.

Functional Configuration of Information Processing Apparatus 30

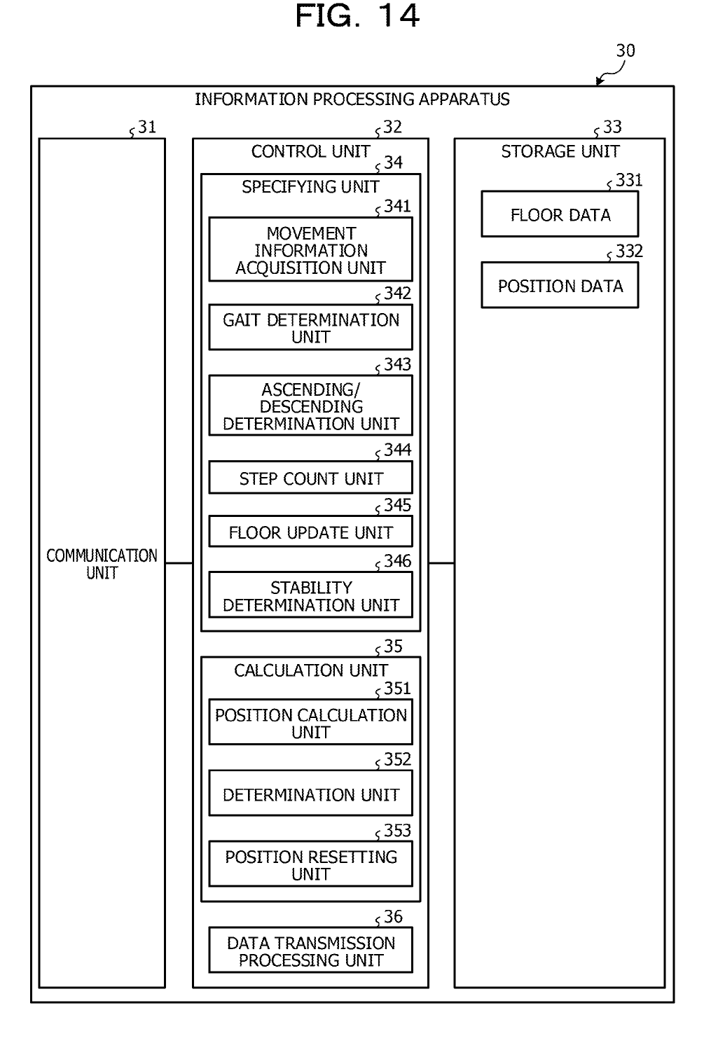

FIG. 14 is a block diagram schematically illustrating an example of a functional configuration of the information processing apparatus according to the second embodiment. A configuration of the control unit 32 of the information processing apparatus 30 is different from that of the first embodiment. That is, as illustrated in FIG. 14, the specifying unit 34 of the control unit 32 further includes a stability determination unit 346. The stability determination unit 346 determines posture stability of the user 100 using the movement information detected by the angular velocity sensor 11. For example, among the movement information, in a normal state, a section in which a posture of the user 100 is stable during the walking period and a state indicating a predetermined value continues for a predetermined period, is used for determination of the posture stability of the user 100. The stability determination unit 346 calculates a variance of the section for determination. In a case where the variance is smaller than a determination reference value, the stability determination unit 346 determines that the posture is stable, and in a case where the variance is larger than the determination reference value, the stability determination unit 346 determines that the posture is not stable. In a case where the variance is the same as the determination reference value, it may be determined that the posture is stable, or it may be determined that the posture is not stable. When fatigue of the user 100 is accumulated, a posture which is a stable operation in a normal state may fluctuate or shake. As a result, the posture becomes unstable. Thus, by determining the posture stability, it is possible to determine whether the user 100 is in a suitable state for performing work or the like. The posture stability is determined by a fluctuation and a shaking of the body. Preferably, the posture stability is determined by using the movement information detected by the angular velocity sensor 11.

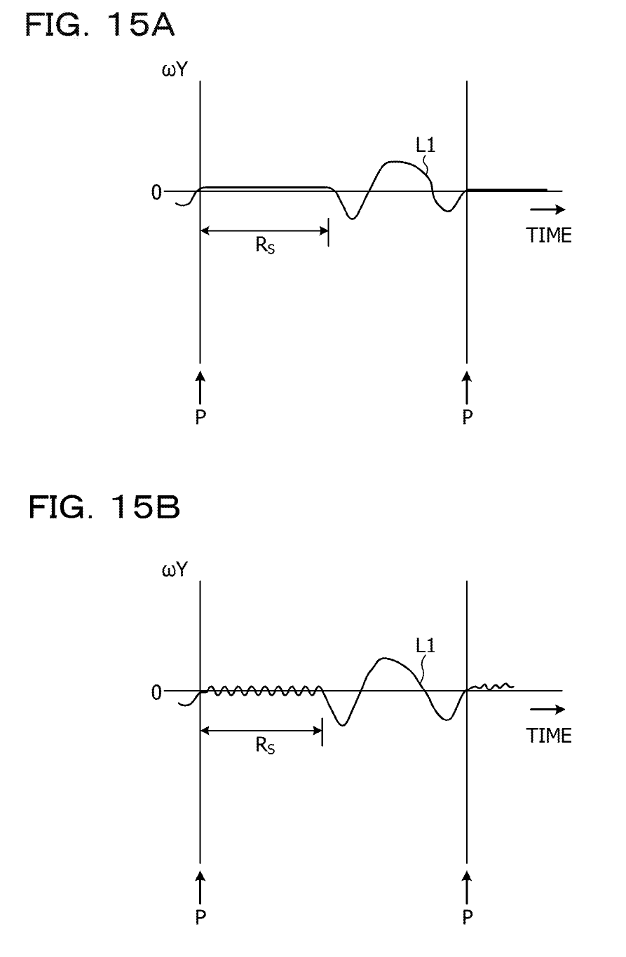

FIGS. 15A and 15B are diagrams illustrating an example of an outline of posture stability determination according to the second embodiment. FIG. 15A is a diagram illustrating an example of a change of the pitch angular velocity ωY with respect to time in a case where a posture is stable, and FIG. 15B is a diagram illustrating an example of a change of the pitch angular velocity ωY with respect to time during the walking period in a case where a posture is not stable. FIGS. 15A and 15B illustrate a temporal change in the pitch angular velocity ωY. In FIGS. 15A and 15B, a horizontal axis represents time, and a vertical axis represents the pitch angular velocity ωY. In addition, here, among behaviors of the pitch angular velocity ωY in the walking period, a stationary section R_{S} in which movement of the foot stops is selected as a determination target.

In a case where the posture is stable, as illustrated in FIG. 15A, in the stationary section R_{S}, a value of the pitch angular velocity ωY is substantially 0, and there is no minor variation. On the other hand, in a case where the posture is not stable, as illustrated in FIG. 15B, in the stationary section R_{S}, although an average value of the pitch angular velocity ωY is substantially zero, a shape of the profile changes like a wave. In the second embodiment, a variance of the pitch angular velocity ωY in the stationary section R_{S} is calculated. In a case where the variance is smaller than a determination reference value indicating an unstable posture, it is determined that the posture is stable, and in a case where the variance is larger than the determination reference value, it is determined that the posture is not stable. In a case where the variance is the same as a predetermined value, it may be determined that the posture is stable, or it may be determined that the posture is not stable.

Here, although a method of determining the posture stability using the pitch angular velocity ωY is described, the posture stability may be determined based on a degree of the body shaking of the user 100 using the roll angular velocity ωX or the yaw angular velocity ωZ.

In FIG. 14, the same reference numerals are given to functional units that exhibit the same functions as the functional units illustrated in FIG. 5, and a description thereof is omitted. Here, the data transmission processing unit 36 transmits the posture stability determined by the stability determination unit 346, together with the time information and information for identifying the user 100, in addition to the position calculated by the position calculation unit 351 or the position which is reset by the position resetting unit 353.

In addition, unlike the first embodiment, the position calculation unit 351 acquires a moving distance of the user 100 in the walking period using the movement information detected by the acceleration sensor 14. The moving distance is obtained by integrating a value of the acceleration included in a signal output from the acceleration sensor 14.

Processing Flow

Although estimation processing of the walking trace in the second embodiment is basically the same as the processing illustrated in the flowchart of FIG. 9 of the first embodiment, the acquisition processing of the movement information between the walking periods in step S19 of FIG. 9 and the gait determination processing in step S20 of FIG. 9 are different from those in the first embodiment. In the following description, portions different from those of the first embodiment will be described.

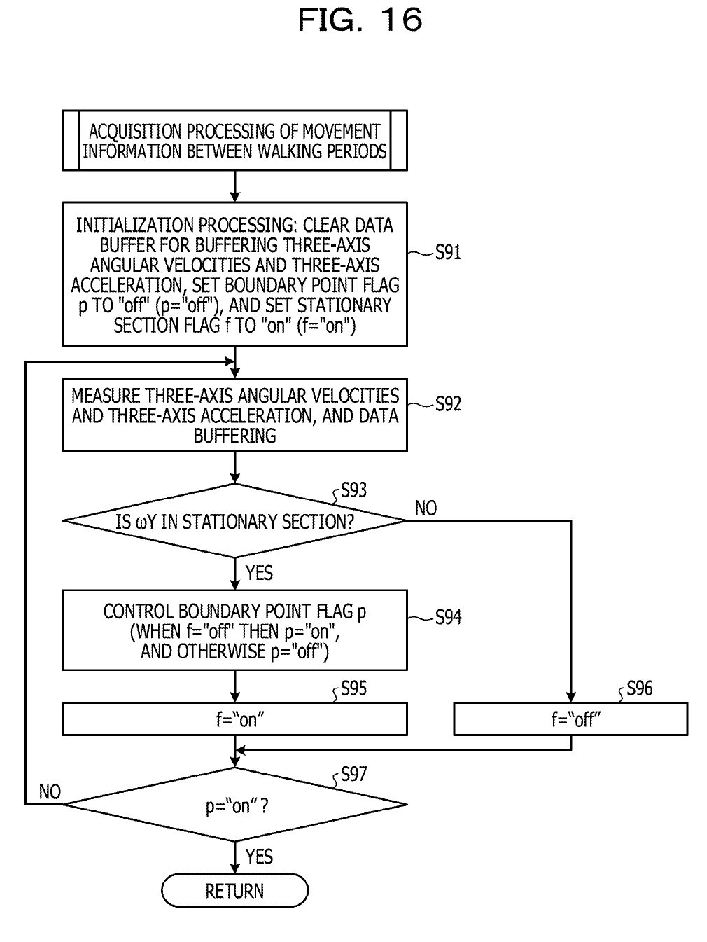

FIG. 16 is a flowchart illustrating an example of a procedure of movement information acquisition processing according to the second embodiment. In the movement information acquisition processing, first, the movement information acquisition unit 341 performs initialization processing (step S91). In the initialization processing, for example, the data buffer for buffering the three-axis angular velocities from the three-axis angular velocity sensor and three-axis acceleration from a three-axis acceleration sensor is cleared. In addition, a boundary point flag p is set to “off”, and a stationary section flag f is set to “on”.

Subsequently, the movement information acquisition unit 341 acquires movement information from the angular velocity sensor 11 of the motion detection device 10 and the acceleration sensor 14 via the communication unit 31, and buffers the movement information in the data buffer (step S92). Thereafter, processing similar to the processing described in steps S53 to S57 of FIG. 10 is executed (steps S93 to S97). That is, in a case where the pitch angular velocity ωY is in the stationary section, the boundary point flag p is “off”, and the stationary section flag f is “on”, or in a case where the pitch angular velocity ωY is not in the stationary section, and the boundary point flag p is “off”, and the stationary section flag f is “off”, the movement information acquisition unit 341 performs buffering of the movement information. In addition, in a case where the pitch angular velocity ωY is in the stationary section, the stationary section flag f is “off”, and the boundary point flag p is “off”, the movement information acquisition unit 341 sets the boundary point P that partitions the walking periods by setting the boundary point flag p to “on”. By the above-described procedure, the movement information acquisition processing ends.

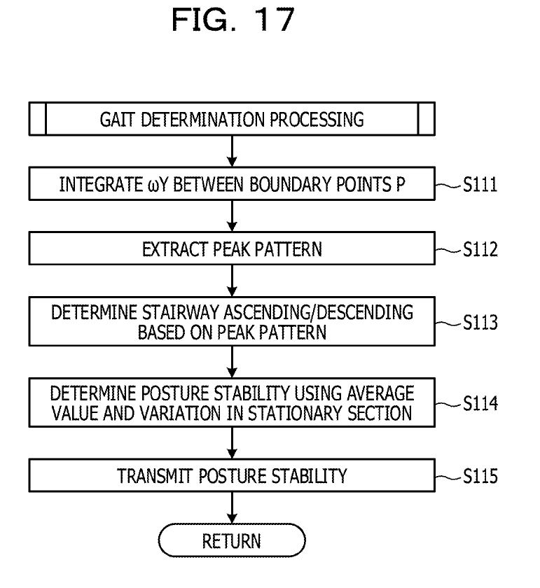

FIG. 17 is a flowchart illustrating an example of a procedure of gait determination processing according to the second embodiment. As in steps S71 to S73 of FIG. 11, the gait determination unit 342 extracts a peak pattern in the walking period by integrating the time-series data (or waveform) of the pitch angular velocity ωY in the walking period with respect to time, and performs determination of stairway ascending and stairway descending based on the extracted peak pattern (steps S111 to S113).

Subsequently, the stability determination unit 346 determines the posture stability of the user 100 using the average value and the variation in the stationary section within the walking period (step S114). In one embodiment, the stability determination unit 346 calculates a variance in the stationary section, and determines the posture stability by comparing the variance with a reference determination value. Thereafter, the data transmission processing unit 36 transmits the posture stability as safety monitoring information, to the position management server 60 (step S115). By the above-described procedure, the gait determination processing ends.

The position management server 60 transmits the safety monitoring information of the user 100 to the service provider information processing terminal 80. In a case where the posture stability of the user 100 is unstable, the service provider information processing terminal 80 transmits information for instructing the information processing apparatus 30 of the user 100 to stop work, or transmits information for instructing the information processing apparatus of an administrator as the user 100 to check a situation of the user 100. In a case where the user 100 is a worker in the building 200, as a state where the posture stability of the user 100 is unstable, a state where physical strength of the user 100 is declined due to fatigue, a state where the user 100 is working beyond the physical strength, or the like may be exemplified.

Aspect of Effect

As described above, based on a fact that the angular velocity has a predetermined value when the user 100 is in a stable state, among the movement information detected by the angular velocity sensor 11, the information processing apparatus 30 according to the present embodiment determines the posture stability of the user 100 by using the average value and the variation of the angular velocity, for a range in which the variance is substantially zero. Then, the determination result is transmitted to the position management server 60, as the safety monitoring information. Thus, it is possible to recognize a safety situation of each user 100, more specifically, a load situation with respect to the physical strength of the user 100, using the safety monitoring information. As a result, it is possible to secure the safety of the user 100 by adopting measures according to the posture stability of the user 100, such as avoiding work in which an excessive load is applied to the user 100.

### Third Embodiment

Although the embodiments relating to the information processing system disclosed herein have been described, the present disclosure may be embodied in a variety of other forms, in addition to the embodiments described above. In the following description, another embodiment included in the present disclosure will be described.

Modification Example (Example in Which the Position Calculation Processing is Performed by the Position Management Server)

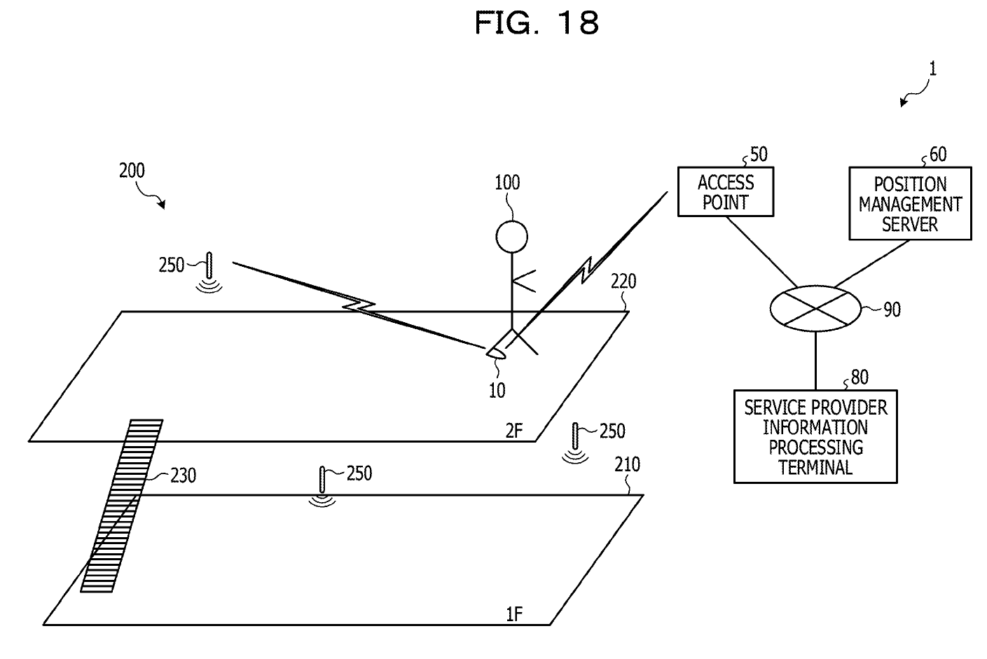

FIG. 18 is a diagram illustrating an example of a configuration of the information processing system according to a third embodiment. In the third embodiment, the information processing apparatus 30 possessed by the user 100 does not exist, and the processing performed in the information processing apparatus 30 according to the first embodiment is performed by the position management server 60. In FIG. 18, the same reference numerals are given to the same configuration as the configuration illustrated in FIG. 1, and a description thereof is omitted. Here, the wireless communication unit 13 of the motion detection device 10 has a function of receiving a beacon signal from the communication apparatus 250, and transmitting the movement information detected by a sensor including the angular velocity sensor 11, the intensity of the beacon signal, and information indicating the installation position of the communication apparatus 250, to the position management server 60 via the access point 50.

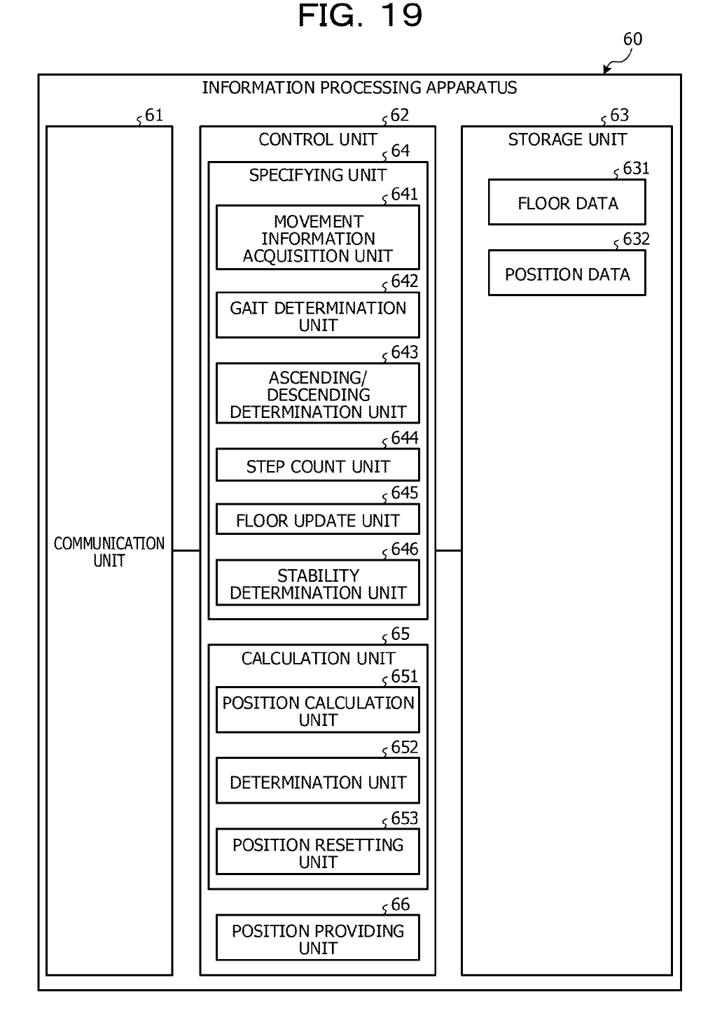

FIG. 19 is a block diagram schematically illustrating an example of a functional configuration of the position management server according to the third embodiment. The position management server 60 includes a communication unit 61, a control unit 62, and a storage unit 63.

The communication unit 61 has a function of receiving the movement information detected by the angular velocity sensor 11 or/and the acceleration sensor 14 and the beacon signal, from the motion detection device 10. In addition, the communication unit 61 also has a function of transmitting data of the user 100 that is stored in the storage unit 63, to the service provider information processing terminal 80, according to an instruction from the service provider information processing terminal 80. The communication unit 61 is realized by, for example, an NIC.

The control unit 62 includes a specifying unit 64, a calculation unit 65, and a position providing unit 66. The control unit 62 is mounted as a central processor, a so-called CPU. The CPU develops an application program for realizing position calculation of the information processing apparatus 30, on a work area of a RAM mounted as a main memory device (not illustrated), as a process. As the RAM, DRAM, SRAM, or the like may be used. In addition, the application program is stored in, for example, a ROM, or an HDD.

The control unit 62 may be not mounted as a central processor, and may be mounted as a MPU or a MCU. In addition, the control unit 62 may also be realized by a hard-wired logic such as an ASIC or an FPGA.

The specifying unit 64 includes a movement information acquisition unit 641, a gait determination unit 642, an ascending/descending determination unit 643, a step count unit 644, a floor update unit 645, and a stability determination unit 646. In addition, the calculation unit 65 includes a position calculation unit 651, a determination unit 652, and a position resetting unit 653.

The movement information acquisition unit 641, the gait determination unit 642, the ascending/descending determination unit 643, the step count unit 644, the floor update unit 645, the stability determination unit 646, the position calculation unit 651, the determination unit 652, and the position resetting unit 653 respectively have the same functions as the movement information acquisition unit 341, the gait determination unit 342, the ascending/descending determination unit 343, the step count unit 344, the floor update unit 345, the stability determination unit 346, the position calculation unit 351, the determination unit 352, and the position resetting unit 353 in the information processing apparatus 30 according to the first embodiment and the second embodiment, and thus a description thereof is omitted.

When receiving an instruction for acquiring the position information of the user 100 from the service provider information processing terminal 80, the position providing unit 66 extracts position data 632 which is stored in association with identification information of the user 100, from the storage unit 63, and transmits the extracted position data 632 to the service provider information processing terminal 80 via the communication unit 61.

The control unit 62 of the position management server 60 illustrated in FIG. 19 corresponds to the configuration of the information processing apparatus 30 illustrated in the second embodiment. Thus, in order to realize the functions described in the first embodiment, the stability determination unit 646 is removed from the configuration illustrated in FIG. 19.

The storage unit 63 stores the floor data 631 and the position data 632. The floor data 631 is information, which indicates a disposition state such as positions of a passage, a room, the communication apparatus 250, an upward entrance of the stairway 230, a downward entrance of the stairway 230 in each floor of the building 200, with respect to a certain position as a coordinate reference. The floor data 631 is prepared for each floor of the building 200.

The position data 632 stores the position calculated by the position calculation unit 651 or the position which is reset by the position resetting unit 653, together with the time information, for each user 100.

The storage unit 63 is mounted as, for example, an HDD or an SSD.

In addition, the position calculation processing of the user 100 that is performed by the position management server 60 is similar to that described with reference to the flowcharts illustrated in FIGS. 9 to 11 and FIGS. 16 and 17, and thus a description thereof is omitted.

In addition, each component of the position management server 60 illustrated in FIG. 19 may not be physically configured as illustrated. That is, a specific form of distribution/integration of the position management server 60 is not limited the form illustrated in FIG. 19, and all or some of components may be functionally or physically configured in arbitrary units by being distributed or integrated according to various loads or usage situations.

In addition, the various processing described in the embodiments may be realized by causing a computer such as a smartphone, a tablet terminal, a personal computer, or a workstation to execute a program prepared in advance. In the following description, an example of a computer that executes a position calculation program having the same function as that of the embodiments, will be described.

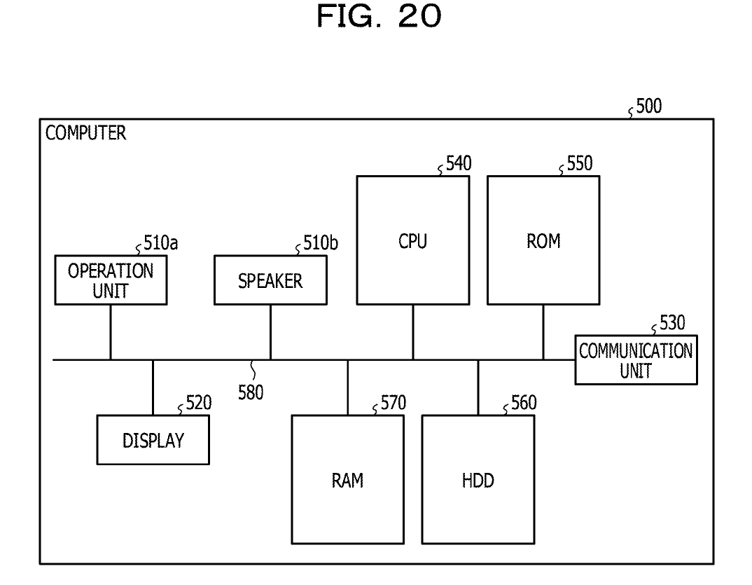

FIG. 20 is a diagram illustrating a hardware configuration of a computer that executes a position calculation program according to the first embodiment to the third embodiment. As illustrated in FIG. 20, a computer 500 includes an operation unit 510a, a speaker 510b, a display 520, a communication unit 530, a CPU 540, a ROM 550, an HDD 560, and a RAM 570. The operation unit 510a, the speaker 510b, the display 520, the communication unit 530, the CPU 540, the ROM 550, the HDD 560, and the RAM 570 are connected to each other via a bus 580. Instead of the HDD 560, an SSD may be used.

In the HDD 560, a position calculation program is stored, the position calculation program exhibiting the same functions as those of the specifying units 34 and 64 (the movement information acquisition units 341 and 641, the gait determination units 342 and 642, the ascending/descending determination units 343 and 643, the step count units 344 and 644, the floor update units 345 and 645, and the stability determination units 346 and 646), the calculation units 35 and 65 (the position calculation units 351 and 651, the determination units 352 and 652, and the position resetting units 353 and 653), and the data transmission processing unit 36, which are illustrated in the first embodiment to the third embodiment. The position calculation program may be integrated or separated, similarly to each component of the specifying units 34 and 64 (the movement information acquisition units 341 and 641, the gait determination units 342 and 642, the ascending/descending determination units 343 and 643, the step count units 344 and 644, the floor update units 345 and 645, and the stability determination units 346 and 646), the calculation units 35 and 65 (the position calculation units 351 and 651, the determination units 352 and 652, and the position resetting units 353 and 653), and the data transmission processing unit 36, which are illustrated in FIG. 5, FIG. 14 or FIG. 19. That is, all data illustrated in the first embodiment to the third embodiment may not be stored in the HDD 560, and data to be used for processing may be stored in the HDD 560.

Under such circumstances, the CPU 540 reads the position calculation program from the HDD 560 and loads the program into the RAM 570. As a result, the position calculation program functions as a position calculation process. The position calculation process loads various data read from the HDD 560 into an area of a storage area of the RAM 570 that is allocated to the position calculation process, and executes various processing using the loaded various data. For example, examples of the processing executed by the position calculation process include the processing illustrated in FIG. 9, FIG. 10, FIG. 11, and FIG. 16 or FIG. 17. The CPU 540 may not operate all the processing units illustrated in the first embodiment to the third embodiment, and processing units corresponding to processing to be executed may be virtually realized.

The position calculation program may not be stored in the HDD 560 or the ROM 550 from the beginning. For example, the position calculation program may be stored in “a portable physical medium” as a flexible disk inserted into the computer 500 that is a so-called FD such as a compact disc (CD)-ROM, a digital versatile disc/digital video disc (DVD), a magneto-optical disk, or an integrated circuit (IC) card. The computer 500 may acquire the position calculation program from the portable physical medium and execute the program. In addition, the position calculation program may be stored in another computer or a server apparatus connected to the computer 500 via a public line, the Internet, a LAN, a WAN, or the like, and the computer 500 may acquire the position calculation program from the another computer or the server apparatus, and execute the program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A position calculation device comprising:
a memory; and
a processor coupled to the memory and the processor configured to:
receive a first beacon signal transmitted from a first transmitter installed in a first floor and a second beacon signal transmitted from a second transmitter installed in a second floor,
perform a first determination of a floor where the position calculation device is positioned based on measurement information of a motion sensor,
perform a second determination of a specific beacon signal from among the first beacon signal and the second beacon signal, the specific beacon signal corresponding to the determined floor, and
calculate a first position of the position calculation device based on the specific beacon signal.

2. The position calculation device according to claim 1, wherein the first determination includes,
specifying a movement state of the position calculation device based on the measurement information, and
determining whether or not the floor where the position calculation device is positioned has been changed based on the movement state.

3. The position calculation device according to claim 2, wherein the movement state of the position calculation device is a walking state of a user who possesses the position calculation device.

4. The position calculation device according to claim 2,
wherein the motion sensor includes a three-axis angular velocity sensor that is mounted to a lower half body below a waist of a user who possesses the position calculation device, the lower half body including a foot, and
wherein the specifying includes,
creating a profile by integrating an angular velocity in a direction perpendicular to a traveling direction and a height direction of the user, which is detected by the three-axis angular velocity sensor, with respect to time during a walking period, for each walking period, and
specifying the movement state based on a shape of the profile.

5. The position calculation device according to claim 1, the processor further configured to,
detect a walking period of a user who possesses the position calculation device based on the measurement information,
calculate a displacement angle of the user based on the measurement information, and
calculate a second position of the position calculation device based on a movement distance corresponding to the walking period and the displacement angle.

6. The position calculation device according to claim 1, the processor further configured to determine posture stability of a user who possesses the position calculation device based on the measurement information.

7. The position calculation device according to claim 1, the processor further configured to,
detect that a user who possesses the position calculation device starts or ends one of ascending a stairway and descending a stairway, based on the measurement information, and
determine that the position calculation device is positioned at an upward entrance of the stairway or a downward entrance of the stairway.

8. A position calculation method executed by a computer, the method comprising:
receiving a first beacon signal transmitted from a first transmitter installed in a first floor and a second beacon signal transmitted from a second transmitter installed in a second floor,
performing a first determination of a floor where a position calculation device is positioned based on measurement information of a motion sensor,
performing a second determination of a specific beacon signal from among the first beacon signal and the second beacon signal, the specific beacon signal corresponding to the determined floor, and
calculating a first position of the position calculation device based on the specific beacon signal.

9. The position calculation method according to claim 8, wherein the first determination includes,
specifying a movement state of the position calculation device based on the measurement information, and
determining whether or not the floor where the position calculation device is positioned has been changed based on the movement state.

10. The position calculation method according to claim 9, wherein the movement state of the position calculation device is a walking state of a user who possesses the position calculation device.

11. The position calculation method according to claim 9,
wherein the motion sensor includes a three-axis angular velocity sensor that is mounted to a lower half body below a waist of a user who possesses the position calculation device, the lower half body including a foot, and
wherein the specifying includes,
creating a profile by integrating an angular velocity in a direction perpendicular to a traveling direction and a height direction of the user, which is detected by the three-axis angular velocity sensor, with respect to time during a walking period, for each walking period, and
specifying the movement state based on a shape of the profile.

12. The position calculation method according to claim 8, further comprising:
detect a walking period of a user who possesses the position calculation device based on the measurement information;
calculate a displacement angle of the user based on the measurement information; and
calculate a second position of the position calculation device based on a movement distance corresponding to the walking period and the displacement angle.

13. The position calculation method according to claim 8, further comprising determine posture stability of a user who possesses the position calculation device based on the measurement information.

14. The position calculation method according to claim 8, further comprising:
detect that a user who possesses the position calculation device starts or ends one of ascending a stairway and descending a stairway, based on the measurement information; and
determine that the position calculation device is positioned at an upward entrance of the stairway or a downward entrance of the stairway.

15. A non-transitory computer-readable recording medium storing a position calculation program that causes a computer to execute a process comprising:
receiving a first beacon signal transmitted from a first transmitter installed in a first floor and a second beacon signal transmitted from a second transmitter installed in a second floor,
performing a first determination of a floor where a position calculation device is positioned based on measurement information of a motion sensor,
performing a second determination of a specific beacon signal from among the first beacon signal and the second beacon signal, the specific beacon signal corresponding to the determined floor, and
calculating a first position of the position calculation device based on the specific beacon signal.
